(19) United States
(12) Patent Application Publication
(10) Pub. No.: US 2013/0174684 A1
(43) Pub. Date: Jul. 11, 2013

(54) STEERING COLUMN ADJUSTMENT

(71) Applicant: Stephen Francis Burns, Huntertown, IN (US)

(72) Inventor: Stephen Francis Burns, Huntertown, IN (US)

(73) Assignee: International Truck Intellectual Property Company, LLC, Lisle, IL (US)

(21) Appl. No.: 13/347,844

(22) Filed: Jan. 11, 2012

(51) Int. Cl. B62D 1/184

(52) U.S. Cl. 74/493

(57) ABSTRACT

A steering column adjustment device that uses a positive locking system comprising in part of teethed locking cleats and teethed sawtooth locking plates. The steering column positive lock mechanism uses a lever to rotate a cross shaft which activates two cam-actuated locks. Once in the unlocked position, the telescopic and tilt adjustment of the steering column can occur at the same time. Once the vehicle driver has achieved the desired tilt and telescopic position for the steering wheel and the steering column, the driver uses the lever to reactivate positive locking system.

### BACKGROUND

A steering column is a device having a structure surrounding a steering shaft, the steering shaft transfers rotational force generated according to the operation of a steering wheel to the wheels of a vehicle. This rotational force is performed by a driver. The steering column supports the operation of the steering shaft and is mounted to a chassis of a vehicle through mounting brackets. Steering column assemblies are often adjustable in a longitudinal direction, that is a telescopic adjustment, and/or adjustable in a vertical direction, also known as a tilt adjustment. The steering column adjustment mechanism can be a manual mechanical system or an automated system. These adjustment mechanisms allow the driver to adjust the degree of overhang and height of the steering wheel depending on the driver's physique and driving posture.

The mechanism for tilt and telescopic adjustable columns typically use either a large single clamp load from a threaded cross shaft and a lever with a threaded fastener or a smaller clamp load spread through a series of sliding friction plates. The clamp load styles or clamp load locking systems use a lever to tighten the fastener, resulting in a long lever travel associated with a threaded clamp load. The present embodiment for a tilt and telescopic adjustable column provides a positive locking system through the engagement of contact plates with teeth and it is controlled by a spring loaded cam-actuated lock system.

### SUMMARY

Embodiments disclosed herein relate to steering column adjustment. In one embodiment, the steering column adjustment device comprises a steering column, an anchored bracket, a steering column bracket, a guide shaft, and a steering column positive lock mechanism. The steering column positive lock mechanism may be unlocked manually with a lever that rotates pivotally around the axis of a cross shaft. The rotation of the cross shaft causes the activation of two cam-actuated locks which in turn allow the disengagement of a positive locking system comprising of locking cleats and sawtooth locking plates.

Once in the unlocked position, the telescopic and tilt displacement of the steering column through the steering column bracket can occur at the same time. Once the vehicle driver has achieved the desired tilt and telescopic adjustment for the steering wheel and the steering column, the driver uses the lever to lock the new position into place. The steering column positive lock mechanism is in the locked position when the lever rotation places the surfaces of the cam-actuated locks into locking contact with each other. In the locked position, each cam-actuated lock produces a linear force along the axis of the cross shaft which in turn forces the surface of the teeth containing locking cleats against the teeth containing sawtooth locking plates forming a positive lock clenched mesh configuration.

### DESCRIPTION OF THE DRAWINGS

FIG. 1 is perspective view of the steering mechanism assembly.

FIG. 1a is perspective view of a steering wheel.

FIG. 1b is perspective view of a steering column adjustment mechanism.

FIG. 1c is perspective view of a steering column and steering gear.

FIG. 2 is a perspective view of the steering column adjustment device.

FIG. 3 is a perspective view of the anchored bracket.

FIG. 4 is a perspective view of the steering column bracket.

FIG. 5a is a perspective view of the steering column positive lock mechanism.

FIG. 5b is an exploded view of the steering column positive lock mechanism.

FIG. 6 is a perspective view of a plate of the cam-actuated lock, cross-shaft and a locking cleat.

FIG. 7a is a top view of a segment of the steering column positive lock mechanism.

FIG. 7b is a top view of a segment of the steering column positive lock mechanism.

FIG. 8 is a perspective view of the sawtooth locking plate, positive ejection mechanism and locking cleat.

FIG. 9a is a close-up view of the anti-rattle compliance nut and the steering column adjustment mechanism.

FIG. 9b is a close-up view of the anti-rattle compliance nut and the steering column adjustment mechanism.

FIG. 10 is a perspective view of the steering column adjustment device.

### DETAILED DESCRIPTION

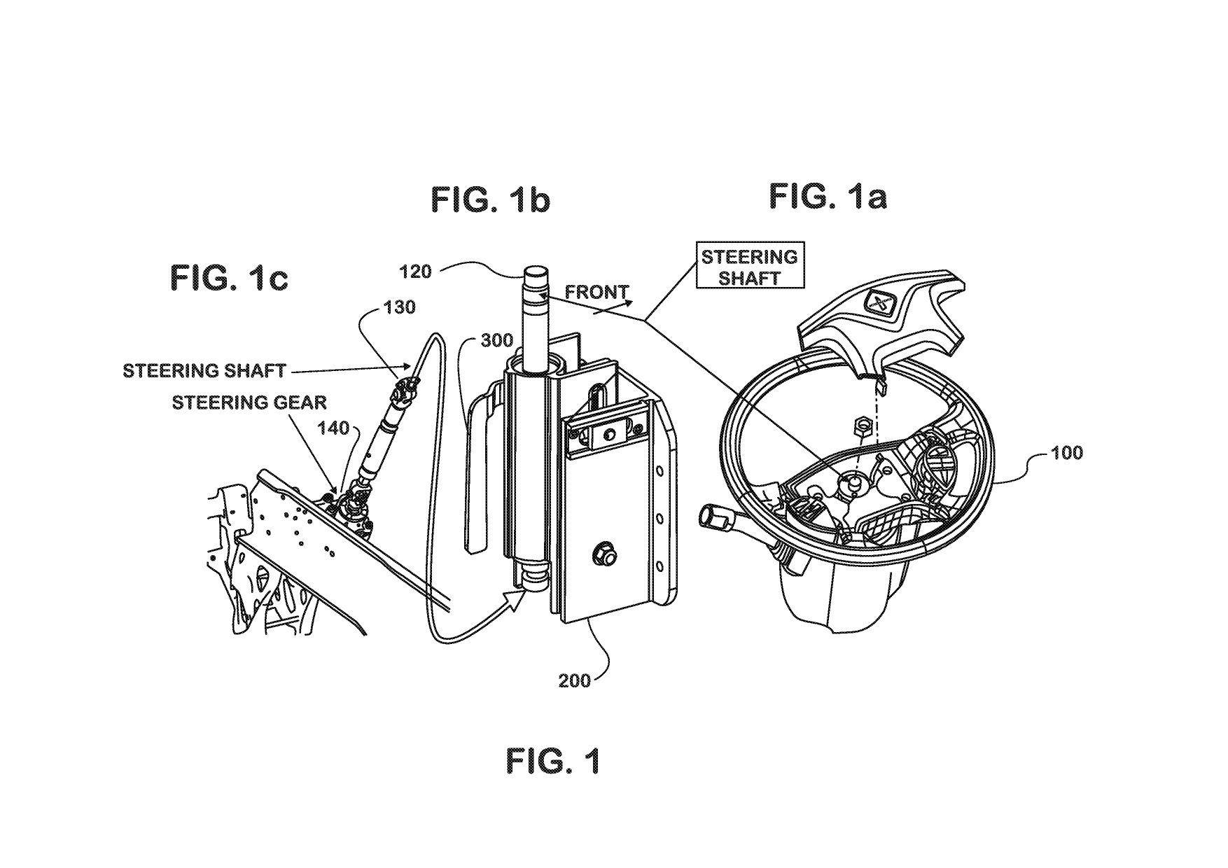

FIG. 1 shows a steering system which may be a type of steering control in motor vehicles and vessels including ships and boats. The steering wheel 100 is the component of the steering system that is manipulated by the driver; the rest of the steering system responds to such driver inputs. The steering wheel 100 is connected to the rest of the system by way of the steering column 120 in FIG. 1b and FIG. 1c, which in turn is connected to the steering gear 140 in FIG. 1a. The steering column 120 may be mounted to the vehicle by any suitable means known in the art.

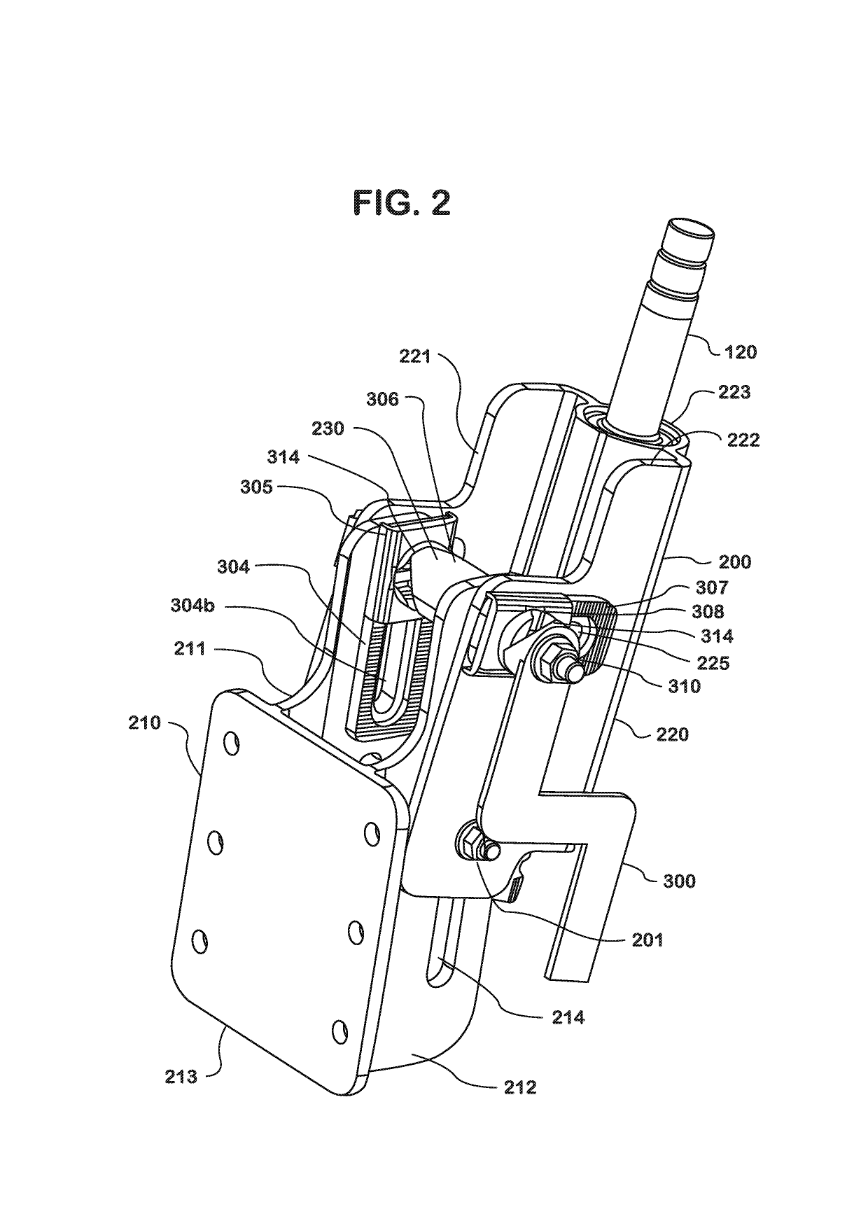

The steering system presented includes a steering column adjustment device 200. The steering column adjustment device 200 in FIG. 2 comprises mainly of a steering column 120, an anchored bracket 210, a steering column bracket 220, a guide shaft 201, and a steering column positive lock mechanism 230. The anchored bracket 210 is configured for attachment to a motor vehicle (not shown in FIG. 2). The steering column bracket 220 supports the steering column 120 and is coupled and locked into position relative to the anchored bracket 210 by way of the guide shaft 201 and the steering column positive lock mechanism 230. Both the guide shaft 201 and the steering column positive lock mechanism 230 traverse through the anchored bracket 210 and the steering column bracket 220. This design allows the steering column 120, while being supported by the steering column bracket 220, to adjust in the tilt and telescopic axis by the displacement of the steering column bracket 220 in relation to the anchored bracket 210.

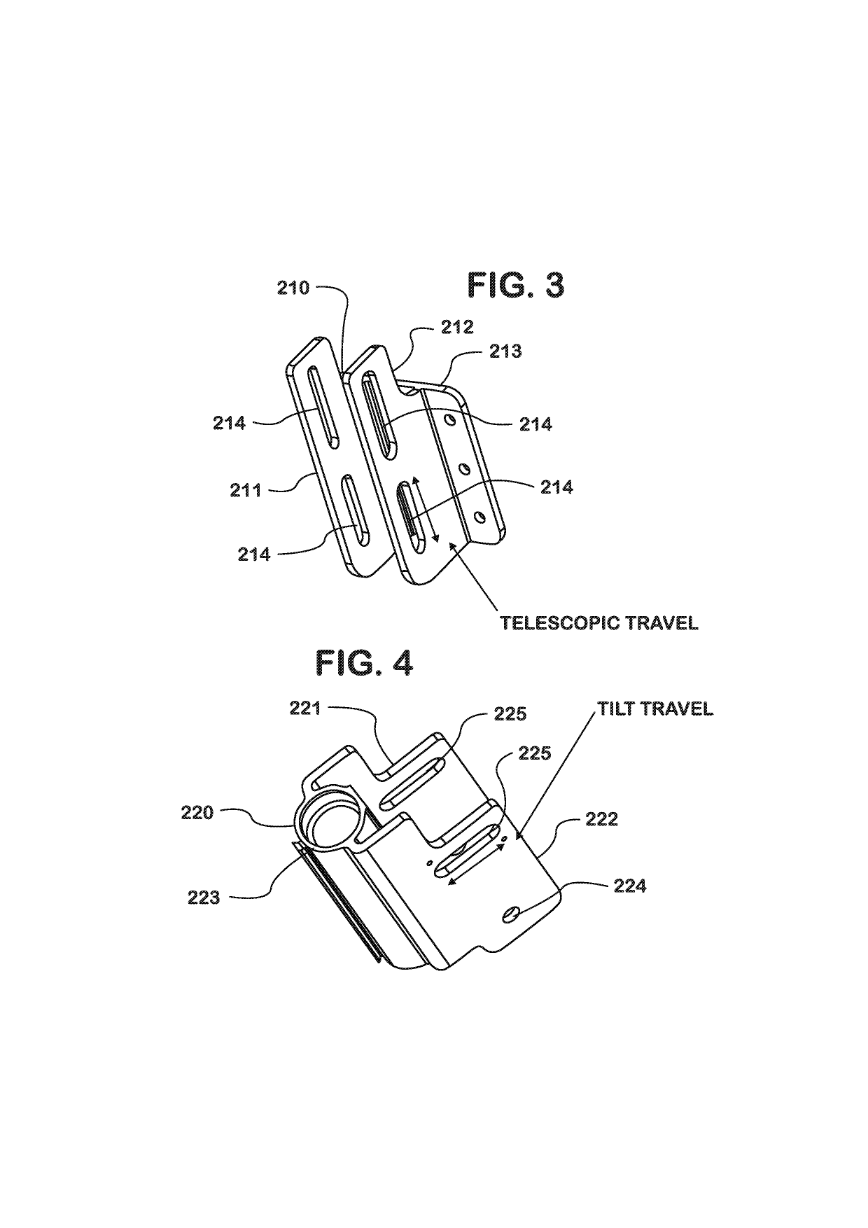

The anchored bracket 210 in FIG. 3 has a first side wall 211 and a second side wall 212 that are on opposite sides and connected by a center wall 213. The first side wall 211 and the second side wall 212 are generally parallel to and spaced from each other and extend in a longitudinal axis. There are two oblong shape apertures 214 placed in series on each side wall 211, 212 and are aligned in a longitudinal axis. These apertures 214 facilitate the telescopic displacement of the steering column 120. The apertures 214 can be of any shape suitable for the telescopic displacement of the steering column bracket 220.

FIG. 4 shows the steering column bracket 220 having with a first side wall 221 and a second side wall 222 that are on opposite sides and connected by a center structure 223. The first side wall 221 and a second side wall 222 are generally parallel to and spaced from each other and extend in a longitudinal axis. Each side wall 221, 222 has at least one hole 224 and at least one aperture 225. The aperture 225 is aligned in approximately perpendicular configuration to the longitudinal axis of the steering column 120 and allows for the tilt adjustment of the steering column bracket 220. The center structure 223 is configured with a hollow cylinder designed to adequately support the steering column 120.

The guide shaft 201 (not completely seen in FIG. 2) may be in the shape of a rod with sufficient length to cross the width of the anchored bracket 210 and the steering column bracket 220 when coupled together in an overlapping fashion. The guide shaft 201 has sufficient length to accommodate the fasteners needed to secure it in place at both ends. The guide shaft 201 has a suitable diameter to fit through the apertures 214, 225 of the anchored bracket 210 and steering column bracket 220. The guide shaft 201 allows for the telescopic displacement of the steering column bracket 220 in relation to the anchored bracket 210 with minimum friction. The guide shaft 201 has a suitable diameter to fit through the hole 224 of the steering column bracket 220 and also allows for pivot rotation facilitating the tilt adjustment of steering column bracket 220.

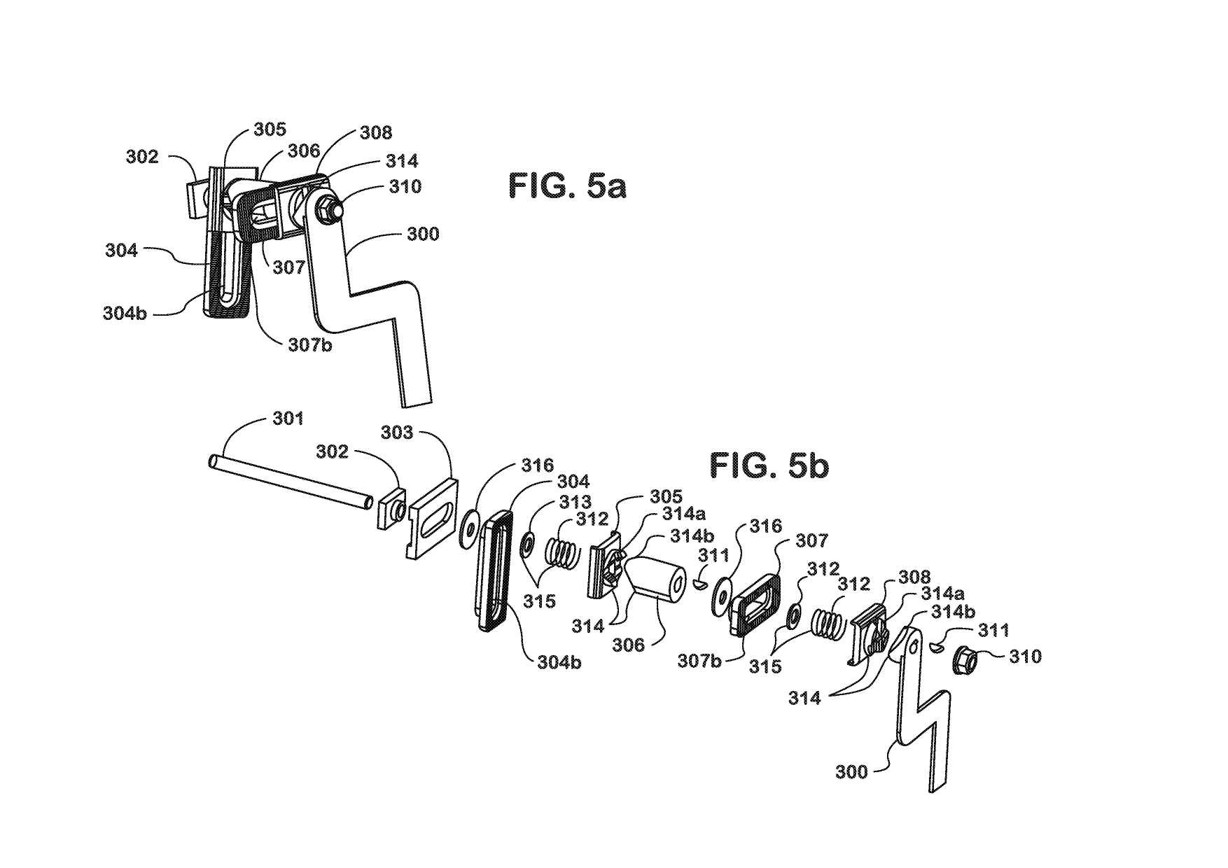

FIGS. 5a and 5b show a functional embodiment of the steering column positive lock mechanism 230. The steering column positive lock mechanism 230 of FIGS. 5a and 5b shows a lever 300 which is the device that the vehicle driver operates by applying force when it is desired to adjust the steering wheel 100. In the embodiment shown in FIG. 5b, the lever 300 serves to rotate the cross shaft 301 that sits within perforations of the following longitudinally aligned components: the steering column bracket 220, the anchored bracket 210, a pair of cam-actuated locks 314, a pair of locking cleats 308, a pair of sawtooth locking plates 307, a pair of positive ejection mechanisms 315, a pair of bushing interfaces 316, a shaft spacer 306, a cross shaft guide track 303 and an anti-rattling compliance nut 302. The cross shaft 301 provides support to the abovementioned components as shown in FIG. 5b and is secured at one end by a torque nut 310 and at the opposite end by the anti-rattle compliance nut 302.

The lever 300 in FIGS. 1b, 2, 5a, 5b, 7a, and 7b consists of a rigid bar that pivots about the cross shaft 301. The shape of the lever 300 in FIGS. 2, 5a, 5b, 7a, and 7b is a polyline; however, the lever 300 can be a rectilinear shape such as in FIG. 1b or any other shape conducive to the present application.

FIG. 5b shows two cam-actuated locks 314. The first cam-actuated lock 314 in FIG. 5b sits and operates between the lever 300 and one of the two locking cleats 308. The second cam-actuated lock 314 in FIG. 5b sits and operates between the shaft spacer 306 and one of the locking cleats 305. The cam-actuated locks 314 work by transforming rotational movement imparted by the lever 300 into rectilinear movement along the axis of the cross shaft 301. The design of the cam-actuated lock 314 may vary while still accomplishing its intended result. FIGS. 5b, 6, 7a, and 7b suggest that a functioning embodiment of the cam-actuated lock 314 comprises of a first plate 314a that is backed against a locking cleat 305, 308 on one side and on the opposite side it has a surface that is adapted to make locking contact with the surface of a second plate 314b. The second plate 314b has a surface adapted to make locking contact with the surface of the first plate 314a on one side and on the opposite side it is attached to a structural member. This structural member can be the lever 300 or the shaft spacer 306; however, the cam-actuated locks 314 can be adapted to function with any structural member or machine element capable of transmitting rotational force to the second plate 314b.

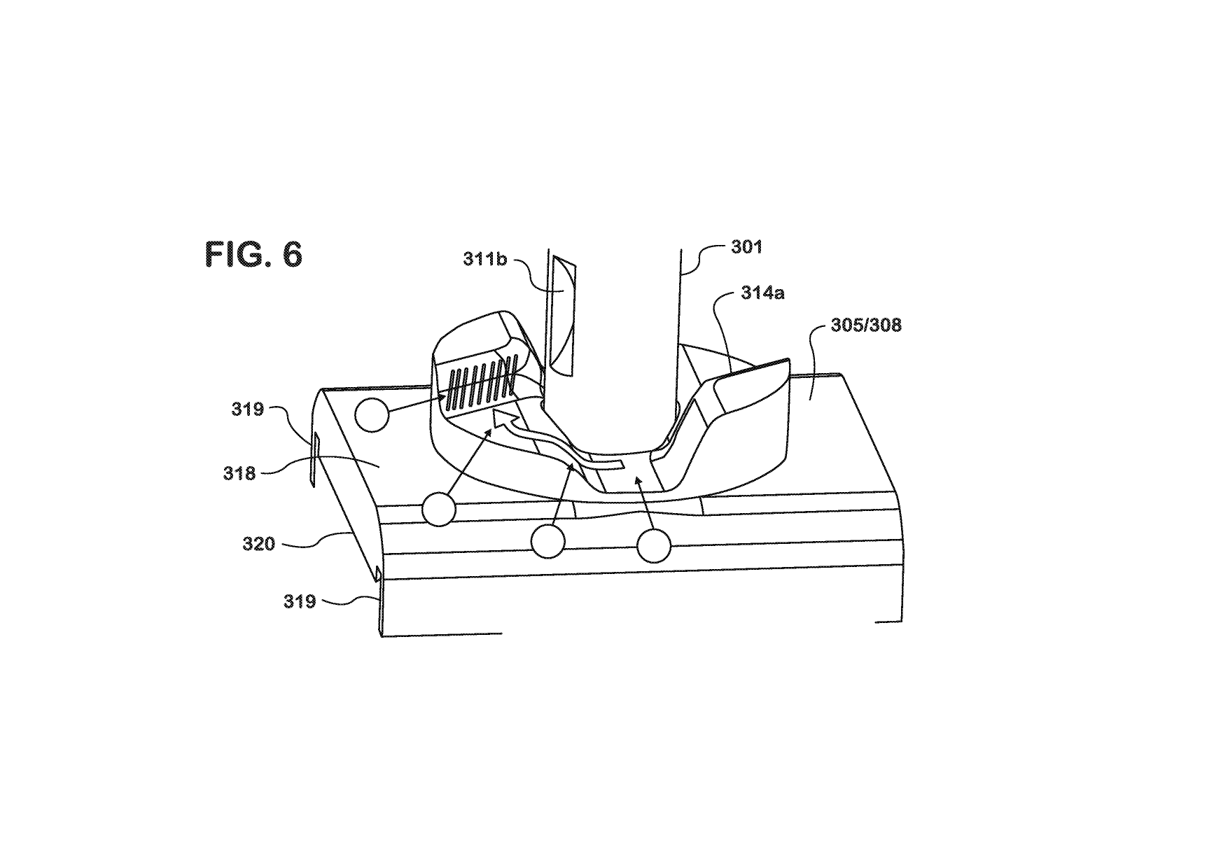

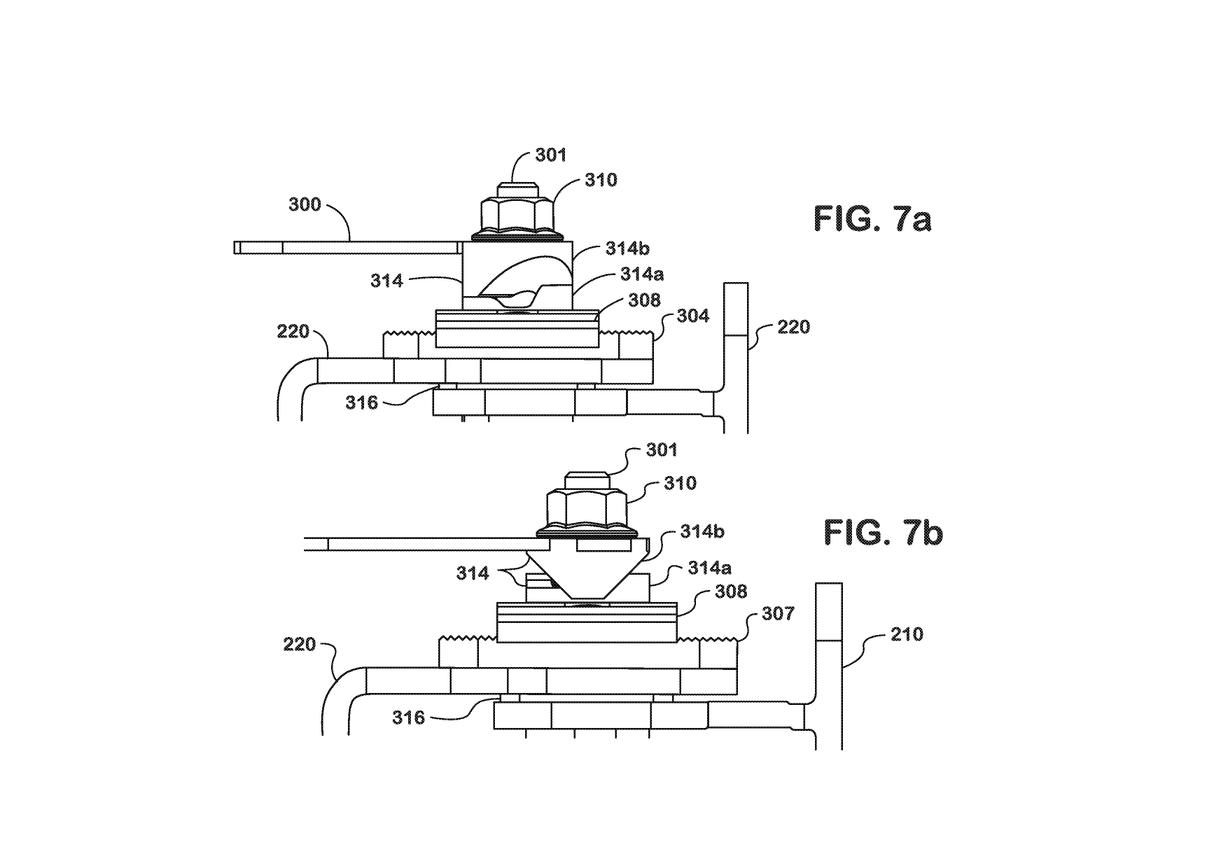

FIG. 6 shows the first plate 314a attached to a locking cleat 305 or 308 and surrounding a cross shaft 301. The first plate 314a of the cam-actuated lock 314 has a valley 1 where a male member of the second plate 314b sits in coupling or locking contact with the female portion or valley 1 of the first plate 314a, shown in FIG. 7b. When rotation of the second plate 314b begins in relation to the stationary first plate 314a, the second plate 314b rises through the ramp 2 in FIG. 6. During the rise motion, the cam-actuated lock 314 forces the locking cleat 305, 308 against the positive ejection mechanisms 315. Each positive ejection mechanism 315 is sandwiched between a locking cleat 305, 308 and a sawtooth locking plate 307, 308. When the rise of the second plate 314b is completed, the cam-actuated lock 314 reaches a resting 3 position, FIG. 6. In the resting position 3, the cam-actuated locks 314 sit in the locked position, FIG. 7a. In the locked position, the teeth 320 containing surface of the locking cleat 305, 308 is pressed against the teeth 320 containing surface of the sawtooth locking plate 304, 307 forming a clenched mesh configuration. The surface of the first plate 314a has a wall 4 that prevents further travel of the second plate 314b which in turn prevent further travel of the lever 300.

FIGS. 5a, 5b, 7a, and 7b show two cam-actuated locks 314. The second plate 314b of the first cam-actuated lock 314 is attached to the lever 300 and the second plate 314b of the second cam-actuated lock 314 is attached to the shaft spacer 306. The shaft spacer 306 is a hollow cylinder 321 wide enough to accommodate the cross shaft 301. The inner surface of the cylinder 321 has a keyway 311a groove to accommodate a woodruff key 311. The second plate 314b of the second cam-actuated lock 314 sits at the cam-actuated lock 314 end of the shaft spacer 306. The opposite end of the shaft spacer 306 has a flat annular surface that may sit against a bushing 316 interface.

In the presented embodiment, both second plates 314b pivotally move in concert to the rotation of the cross shaft 301. The rotation of the cross shaft 301 is controlled by adjustment of the lever 300. In order to facilitate a synchronous axial rotation of the shaft spacer 306 and the lever 300, the steering column adjustment device 200 further comprises a set of woodruff keys 311 that connects the cross shaft 301 to the shaft spacer 306 and to the lever 300. The woodruff keys 311 facilitate the transmission of a driver applied force from the lever 300 throughout the cross shaft 301.

The woodruff keys 311 in FIG. 5b are semicircular shaped keys that when installed leave a protruding tab. FIG. 6 shows a keyway 311b on the cross shaft 301 that comprises of a semi-circular pocket for the mating with the protruding part of the woodruff key 311. It can be appreciated, that other machine elements can serve as alternatives to the woodruff key 311 while functioning within the scope of the disclosed embodiment. Any machine element that prevents relative rotation between the cross shaft 301 and both the shaft spacer 306 and the lever 300 or any structural member attached to the cam-actuated locks 314 and that also allows torque to be transmitted through the cross shaft 301 would be suitable. In addition, the same torque transmission could be achieved by alternate means such as a joining of materials method, for instance welding, soldering or brazing in the case of metal components.

Each locking cleat 305, 308 in FIGS. 2, 5b, 6, 7a, 7b and 8 comprises of a main panel 318 configured to hold the first plate 314a of a cam-actuated lock 314 on one side and on the opposite side has teeth 320 that allow for the pairing of such locking cleat 305, 308 to the teeth 320 of a sawtooth locking plate 304, 307. Two out of the four edges of the locking cleats 305, 308 comprise of two arms 319 protruding from the main panel 318 and extending the length of the edge. The two arms 319 extend in a parallel axis in relation to the cross shaft 301 axis and are configured to be of the appropriate length to partially cover the periphery of the sawtooth locking plates 304, 307 in both the locked and unlocked position. As mentioned above, the locked position occurs when the locking cleats 305, 308 and the sawtooth locking plates 304, 307 are in a clenched meshed configuration. In the unlocked position, the two arms 319 are long enough wrap over the sides of the sawtooth locking plates 304, 307 and are rigid enough to prevent the axial rotation of locking cleat 305, 308 while the cam-actuated lock 314 components are being engaged. The resulting positive lock system means minimal rattling and minimal loosening or slipping of parts due to vibrations from operating the vehicle.

The steering column adjustment device 200 in the presented embodiment has at least two sawtooth locking plates 304, 307. One of the two sawtooth locking plates 304 of FIGS. 2, 5a, and 5b is fixedly attached to the anchored bracket 210 and overlaying one of the anchored bracket apertures 214. Both the sawtooth locking plate 304 and the anchored bracket 210 have equivalently oblong shaped and overlapping apertures 304a, 214, respectively. The aperture 214 in the anchored bracket 210 and sawtooth locking plate 304 can be of any shape suitable for the telescopic displacement of the steering column bracket 220.

A second sawtooth locking plate 307 in FIGS. 2, 5a, and 5b is fixedly attached to steering column bracket 220 and overlaying one of the steering column bracket apertures 225. Both the sawtooth locking plate 307 and the steering column bracket 220 have equivalently shaped and overlapping apertures 307a and 225. The aperture 225 in the steering column bracket 220 and sawtooth locking plate 307 can be of any shape suitable for the tilt displacement of the steering column bracket 220.

The surface of the sawtooh locking plates 304, 307 comprises of teeth 320 in the shape of a sawtooh wave, but any suitable teeth shape may yield the intended outcome. A sawtooh locking plate 304, 307 would have teeth capable of being threaded and clenched into a locking configuration with a locking cleat 305, 308.

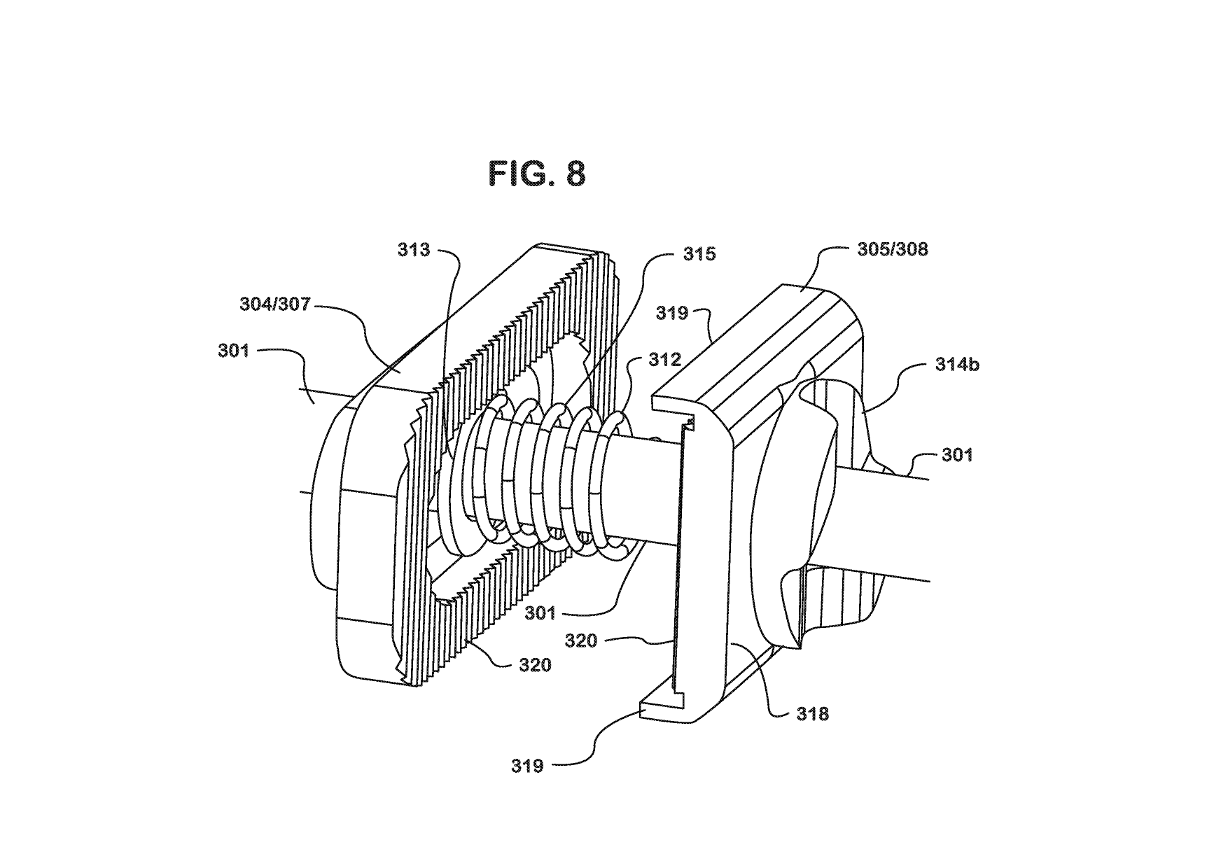

The positive ejection mechanisms 315 in FIG. 5b and FIG. 8 comprise of at least one spring 312 and at least one washer 313. The positive ejection mechanism 315 is sandwiched between a locking cleat 305, 308 and a sawtooth locking plate 304, 307. The spring 312 load contributes to the quick release of the steering column positive lock mechanism 230 by forcing the disengagement of the locking cleat 305, 308 from the sawtooth locking plates 304, 307 once the lever 300 is rotated into the unlocked position.

The steering column positive lock mechanism 230 further comprises of a bushing 316 interface between the sawtooth locking plates 304, 307 and the adjacent structural members as shown in FIGS. 5a and 5b. The adjacent structural members may be the shaft spacer 306, the cross shaft guide track 303, the steering column bracket 220 or the anchored bracket 210. The bushing 316 interface can be made out of synthetic rubber, polyurethane or any suitable material. The bushing 316 provides an interface between the two parts, damping the energy transmitted through the bushing 316 while allowing a certain amount of movement.

The torque nut 310 in FIGS. 2, 5a, 5b, 7a, and 7b is a threaded fastener that secures the lever 300 to the cross shaft 301 and applies a clamp load throughout the cross shaft 301 when tightened. Furthermore, the torque nut 310 may function as a re-adjustment tool. As the components of the steering column positive lock mechanism 230 may wear with time and may become loose, the torque nut 310 can be re-torqued in order to maintain the proper clamp load throughout the mechanism by re-tightening the aforementioned components back into position.

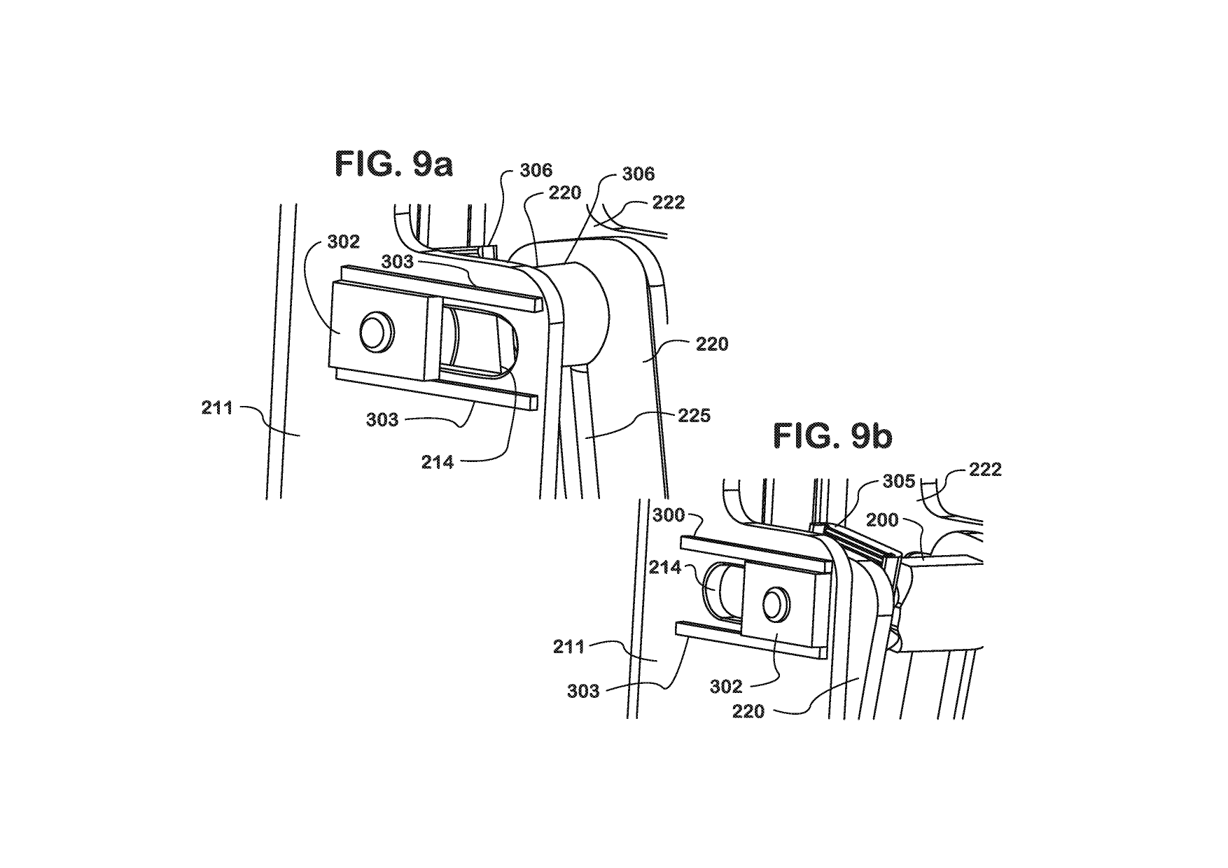

The anti-rattle compliance nut 302 in FIGS. 5b, 9a, and 9b is a threaded fastener that secures the steering column positive lock mechanism 230 to the anchored bracket 210. In addition, because the anti-rattle compliance nut 302 is threaded, when the cross shaft 301 rotates to activate the cam-actuated locks 314, the threads of the anti-rattle compliance nut 302 are pulled against the cross shaft 301 threads creating additional clamp load. The additional clamp load prevents rattling of the steering column positive lock mechanism 230 during the operation of the motor vehicle.

The steering column 120 becomes unlocked when the lever 300 is rotated pivotally around the axis of the cross shaft 301 in a predetermined direction. The rotation of the cross shaft 301 causes the attached cam-actuated locks 314 to shift into an unlocked formation with each other allowing a linear displacement of the locking cleats 305, 308 by way of the positive ejection mechanisms 315. The positive ejection mechanisms 315 are sandwiched between the locking cleats 305, 308 and the sawtooth locking plates 304, 307. The positive ejection mechanisms 315 linearly push apart the locking cleats 305, 308 away from sawtooth locking plates 304, 307 fully disengaging the clenched meshed configuration, FIGS. 7b and 8.

Once in the unlocked position, FIG. 7b, the telescopic and tilt displacement of the steering column bracket 220 in relation to the anchored bracket 210 can occur because the positive locks have been synchronously disengaged. The synchronous dual axis displacement can occur when the guide shaft 201 moves freely through the telescopic axis aperture 214. In the interim, the guide shaft 201 also serves as a pivot point for the tilt displacement of the steering column bracket 220. The cross shaft 301 within the steering column positive lock mechanism 230 can move in the telescopic axis due to the anchored bracket 210 apertures 214. The cross shaft 301 within the steering column positive lock mechanism 230 cannot move in the tilt axis itself but due to the tilt axis apertures 225 of the steering column bracket 220, the upper portion of the steering column bracket 220 can move in the tilt axis.

Once the vehicle driver has achieved the desired tilt and telescopic position, the driver uses the lever 300 to lock the new position in place. The steering column positive lock mechanism 230 is in the locked position when the lever 300 rotation places the surfaces of the cam-actuated locks 314 into locking contact with each other, FIG. 7a. In the locked position, each cam-actuated 314 lock produces a linear force along the axis of the cross shaft 301 which in turn forces the teeth 320 containing surface of the locking cleats 305, 308 against the teeth 320 containing surface of the sawtooth locking plates 304, 307 forming a positive lock clenched mesh configuration.

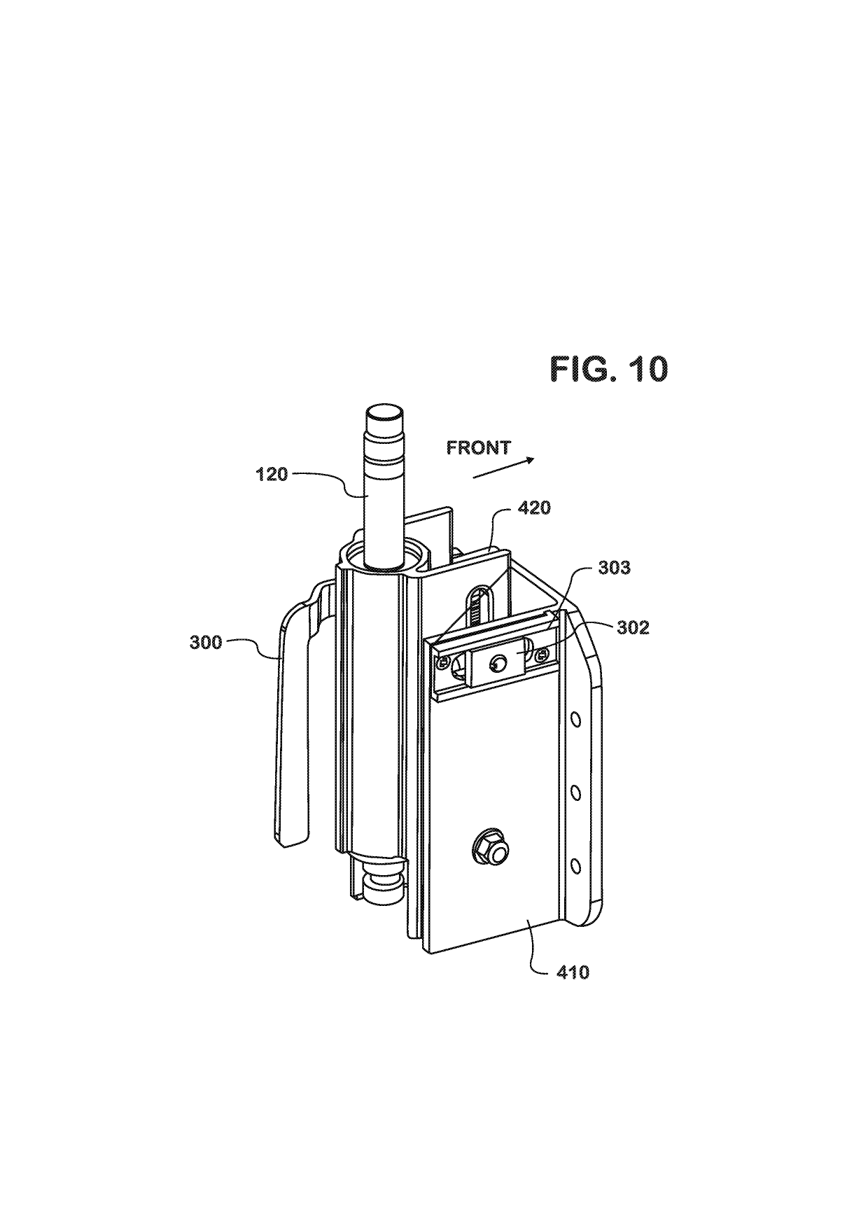

FIGS. 1b, 9a, 9b, 10 shows an alternative embodiment of the steering column adjustment device 200. The anchored bracket 410 of this embodiment is configured with a hole 224 and an aperture 225 for the tilt adjustment of the steering column 120 and the steering column bracket 420 is configured with two apertures 214 for telescopic adjustment of the steering column.

What is claimed is:

1. A steering column adjustment device for a motor vehicle comprising:
a steering column,
an anchored bracket,
a steering column bracket,
a guide shaft, and a
a steering column positive lock mechanism,
the anchored bracket is configured for attachment to the motor vehicle, the steering column bracket supports the steering column and is coupled and locked into position relative to the anchored bracket by way of the guide shaft and the steering column positive lock mechanism each traversing through the anchored bracket and the steering column bracket.

2. The steering column adjustment device of claim 1, wherein the steering column positive lock mechanism comprises:
a lever,
a cross shaft,
at least one cam-actuated lock,
at least one locking cleat,
at least one sawtooth locking plate,
at least one positive ejection mechanism,
at least one shaft spacer,
at least one anti-rattle compliance nut, and at least one torque nut;
the cross shaft passes through perforations in the lever, the steering column bracket, the anchored bracket, the at least one cam-actuated lock, the at least one locking cleat, the at least one sawtooth locking plate, the at least one positive ejection mechanism and the at least one shaft spacer which are aligned longitudinally;
the cross shaft is secured in one end by the at least one torque nut and in an opposite end by the at least one anti-rattle compliance nut.

3. The steering column adjustment device of claim 1, wherein the anchored bracket has at least two telescopic apertures aligned in series along the longitudinal axis of the steering column for the telescopic adjustment of the steering column bracket and the steering column bracket has at least one hole and at least one tilt aperture, the tilt aperture is aligned approximately perpendicularly to the longitudinal axis of the steering column for the tilt adjustment of the steering column bracket.

4. The steering column adjustment device of claim 1, wherein the anchored bracket has at least one hole and at least one tilt aperture, the at least one tilt aperture is aligned perpendicularly to the longitudinal axis of the steering column for tilt adjustment of the steering column bracket and the steering column bracket has at least two telescopic apertures aligned in series along a longitudinal axis of the steering column for telescopic adjustment of the steering column bracket.

5. The steering column adjustment device of claim 2, wherein at least one cam-actuated lock further comprises:
a first plate that is backed against one of the locking cleats on one side and on the opposite side has a surface that is adapted to make locking contact with the surface of a second plate,
the second plate has a surface adapted to make locking contact with the surface of the first plate on one side and on the opposite side is attached to a structural member that makes the second plate pivotally movable in concert with the rotation of the cross shaft, the movement of the second plate in relation to the first plate changes the steering column positive lock mechanism between the locked position and the unlocked position.

6. The steering column adjustment device of claim 5, wherein the structural member is the lever.

7. The steering column adjustment device of claim 5, wherein the structural member is the shaft spacer.

8. The steering column adjustment device of claim 5, wherein the steering column positive lock mechanism is configured with two cam-actuated locks, the first cam-actuated lock is operated by the lever and the second cam-actuated locks is operated by the shaft spacer.

9. The steering column adjustment device claim 8, wherein the steering column positive lock mechanism has at least two sawtooth locking plates,
at least one sawtooth locking plate is fixedly attached to the anchored bracket and overlaying one of the anchored bracket apertures and both the sawtooth locking plate and the anchored bracket have equivalently shaped and overlapping apertures; and
at least one sawtooth locking plate is fixedly attached to the steering column bracket and overlaying one of the steering column bracket apertures and both the sawtooth locking plate and the steering column bracket have equivalently shaped and overlapping apertures.

10. The steering column adjustment device of claim 9, wherein positive ejection mechanisms comprise of at least one spring and at least one washer.

11. The steering column adjustment device of claim 10, wherein steering column positive lock mechanism further comprises a machine element that connects the cross shaft to any structural member attached to the cam-actuated locks whereby the machine element facilitates the transmission of an operator applied force from the lever throughout the cross shaft.

12. The steering column adjustment device of claim 11, wherein steering column positive lock mechanism further comprises a bushing interface between the sawtooth locking plates and the adjacent structural members.

13. The steering column adjustment device of claim 11, wherein the steering column is adjustable in the telescopic axis while in the unlocked position by the displacement of the steering column bracket in relation to the anchored bracket by way of the guide shaft and cross shaft displacement and in the tilt axis by way of steering column bracket rotation about the axis of the guide shaft and tilt displacement of the upper portion of steering column bracket.

14. The steering column adjustment device of claim 11, wherein the steering column positive lock mechanism is in the locked position when the lever rotation places the surfaces of the cam-actuated locks in locking contact with each other; in the locked position each cam-actuated lock produces a linear force along the axis of the cross shaft which in turn forces the surface of the locking cleats against the surface of the sawtooth locking plates forming a clenched mesh configuration; and the unlocked position occurs when the lever rotation places the surfaces of the cam-actuated lock into an unlocked formation with each other allowing a linear displacement of the locking cleats due to the positive ejection mechanisms which are sandwiched between the locking cleats and the sawtooth locking plates, the positive ejection mechanisms linearly pushes apart the locking cleats away from sawtooth locking plates fully disengaging the clenched meshed configuration.

15. A steering column adjustment mechanism for a motor vehicle, comprising:
a steering column,
an anchored bracket,
a steering column bracket,
a guide shaft,
the anchored bracket is configured for attachment to the motor vehicle, the steering column bracket supports the steering column and is coupled and locked into position relative to the anchored bracket by way of the guide shaft and a steering column adjustment mechanism each traversing through the anchored bracket and the steering column bracket,
the steering column bracket adjustment mechanism comprising,
a lever,
at least one cam-actuated lock,
at least one locking cleat,
at least one sawtooth locking plate,
at least one positive ejection mechanism,
at least one shaft spacer,
at least one anti-rattle compliance nut, and at least one torque nut;
a cross shaft passes through perforations in the lever, the anchored bracket, the steering column bracket, the at least one cam-actuated lock, the at least one locking cleat, the at least one sawtooth locking plate, the at least one positive ejection mechanism and the at least one shaft spacer which are aligned longitudinally;
the cross shaft is secured in a lever end by the at least one torque nut and in an opposite end by the at least one anti-rattle compliance nut.
